(19) United States
(12) Patent Application Publication
(10) Pub. No.: US 2025/0097788 A1
(43) Pub. Date: Mar. 20, 2025

(54) RADIO BASE STATION AND RADIO COMMUNICATION METHOD

(71) Applicant: NTT DOCOMO, INC., Tokyo (JP)

(72) Inventors: Souki Watanabe, Tokyo (JP); Tianyang Min, Tokyo (JP)

(73) Assignee: NTT DOCOMO, INC., Tokyo (JP)

(21) Appl. No.: 18/292,198

(22) PCT Filed: Jul. 28, 2021
(86) PCT No.: PCT/JP2021/027976

§ 371 Date: Jan. 25, 2024

(51) Int. Cl. H04W 36/00

(52) U.S. Cl. CPC H04W 36/0064

(57) ABSTRACT

A radio base station includes: a control unit that controls an execution of a procedure for an addition/change of a secondary cell; a reception unit that receives a first message relating to the secondary cell from another base station; and a transmission unit that transmits a second message including update information of an execution condition of the procedure for the addition/change to another base station when receiving the first message.

### TECHNICAL FIELD

The present disclosure relates to a radio base station and a radio communication method that support a procedure for an addition/change of a secondary cell (a secondary node).

### BACKGROUND ART

The 3rd Generation Partnership Project (3GPP) has prepared a specification for the 5th generation mobile communication system (which may be called 5G, New Radio (NR), or Next Generation (NG)), and is also in the process of specifying the next generation called Beyond 5G, 5G Evolution, or 6G.

For example, in Release-17 of 3GPP, the expansion of Multi-RAT Dual Connectivity (MR-DC) has been studied (NON-PATENT LITERATURE 1).

Specifically, in order to achieve an addition or a change of a Primary SCell (PSCell) more efficiently, support of a procedure for an addition/change of a conditional secondary cell (a secondary node) in which the procedure is simplified (conditional PSCell addition/change) has been studied. According to the conditional PSCell addition/change, a terminal (User Equipment, UE) can define an execution condition for determining whether to add or change a PSCell.

Meanwhile, if a secondary node (SN) uses a high frequency band such as FR2 (24.25 GHz to 52.6 GHz), an addition or a change of a PSCell is likely to fail due to radio wave properties. For this reason, studies have been conducted to improve the reliability of conditional PSCell addition/change (NON-PATENT LITERATURE 2).

### CITATION LIST

### Non-Patent Literature

NON-PATENT LITERATURE 1: “Revised WID on Further Multi-RAT Dual-Connectivity enhancements”, RP-201040, 3GPP TSG RAN Meeting #88e, 3GPP, June 2020

NON-PATENT LITERATURE 2: “Report of 3GPP TSG RAN WG2 meeting #114-e, Online”, 3GPP TSG RAN WG2 meeting #114-e, 3GPP, May 2021

### SUMMARY OF THE INVENTION

In order to improve the reliability of conditional PSCell addition/change, a method for appropriately updating an execution condition of an addition/change of a PSCell has been studied. However, there is room for further consideration regarding a specific update method, and reduction of delay in update.

Therefore, the following disclosure has been made in view of such circumstances, and an object of the present disclosure is to provide a radio base station and a radio communication method capable of appropriately updating an execution condition of an addition/change of a PSCell.

An aspect of the present disclosure is a radio base station (for example, gNB 100B) including: a control unit (control unit 140) that controls an execution of a procedure for an addition/change of a secondary cell; a reception unit that receives a first message relating to the secondary cell from another base station; and a transmission unit (RRC/Xn processing unit 120) that transmits a second message including update information of an execution condition of the procedure for the addition/change to another base station when receiving the first message.

An aspect of the present disclosure is a radio communication method including: a step of controlling an execution of a procedure for an addition/change of a secondary cell; a step of receiving a first message relating to the secondary cell from another base station; and a step of transmitting a second message including update information of an execution condition of the procedure for the addition/change to another base station when receiving the first message.

An aspect of the present disclosure is a radio base station (for example, gNB 100B) including: a control unit (control unit 140) that controls an execution of a procedure for an addition/change of a secondary cell; and a reception unit (RRC/Xn processing unit 120) that receives a message relating to the addition/change of the secondary cell from another base station, in which the control unit determines whether an execution condition of the procedure for the addition/change is updated, based on identification information of the secondary cell included in the message.

An aspect of the present disclosure is a radio communication method including: a step of controlling an execution n of a procedure for an addition/change of a secondary cell; a step of receiving a message relating to the addition/change of the secondary cell from another base station; and a step of determining whether an execution condition of the procedure for the addition/change is updated, based on identification information of the secondary cell included in the message.

### BRIEF DESCRIPTION OF THE DRAWINGS

FIG. 1 is an overall schematic diagram of a radio communication system 10.

FIG. 2 is a functional block diagram of an eNB 100A and a gNB 100B.

FIG. 3 is a functional block diagram of UE 200.

FIG. 4 is a diagram illustrating a sequence example (part 1) of SN-initiated conditional PSCell change.

FIG. 5 is a diagram illustrating an example of a relationship between a serving cell of a T-SN and candidate cells specified by a S-SN.

FIG. 6 is a diagram illustrating a sequence example (part 2) of SN-initiated conditional PSCell change.

FIG. 7 is a diagram illustrating a sequence example (part 3) of SN-initiated conditional PSCell change.

FIG. 8 is a diagram illustrating a configuration example (ASN.1 format) of CG-Config according to operation example 1.

FIG. 9 is a diagram illustrating an example of an operation flow of a MN according to operation example 2.

FIG. 10 is a diagram illustrating an example of a hardware configuration of the eNB 100A, the gNB 100B, and the UE 200.

### DESCRIPTION OF EMBODIMENTS

Embodiments will be described below with reference to the drawings. Note that the same or similar reference numerals have been attached to the same functions and configurations, and the descriptions thereof will be omitted as appropriate.

### (1) Overall Schematic Configuration of Radio Communication System

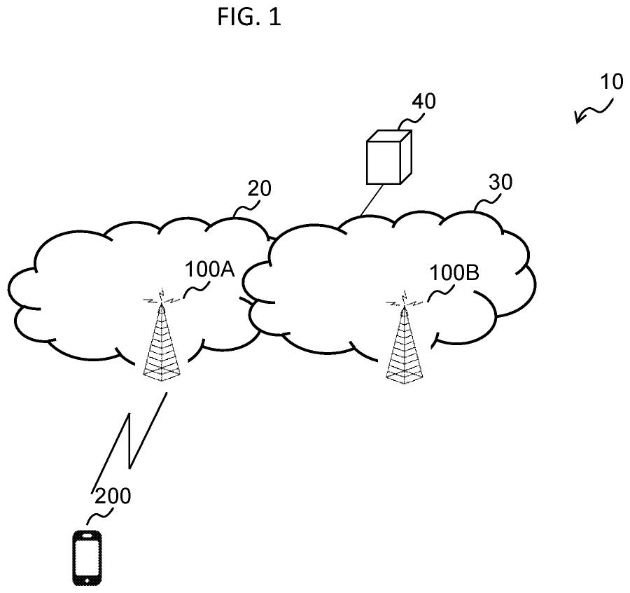

FIG. 1 is an overall schematic diagram of a radio communication system 10 according to the present embodiment. The radio communication system 10 is a radio communication system according to Long Term Evolution (LTE) and 5G New Radio (NR). LTE may be referred to as 4G, or NR may be referred to as 5G. The radio communication system 10 may be a radio communication system according to a system called Beyond 5G, 5G Evolution, or 6G.

LTE and NR may be interpreted as radio access technology (RAT). In the present embodiment, LTE may be referred to as a first radio access technology, and NR may be referred to as a second radio access technology.

The radio communication system 10 includes an Evolved Universal Terrestrial Radio Access Network 20 (hereinafter, E-UTRAN 20), and a Next Generation-Radio Access Network 30 (hereinafter, NG RAN 30). The radio communication system 10 also includes a terminal 200 (hereinafter, UE 200, User Equipment).

The E-UTRAN 20 includes an eNB 100A, which is a radio base station according to LTE. The NG RAN 30 includes a gNB 100B, which is a radio base station according to 5G (NR). The NG RAN 30 may be connected to a User Plane Function 40 (hereinafter, UPF 40), which is included in the 5G system architecture and provides user plane functionality. The E-UTRAN 20 and NG RAN 30 (which may be eNB 100A or gNB 100B) may be referred to simply as a network.

The eNB 100A, the gNB 100B, and the UE 200 may support carrier aggregation (CA) using a plurality of component carriers (CCS), dual connectivity for simultaneously transmitting component carriers between a plurality of NG-RAN Nodes and UE, and the like.

The eNB 100A, the gNB 100B, and the UE 200 perform radio communication via a radio bearer, specifically, via a Signaling Radio Bearer (SRB) or a DRB Data Radio Bearer (DRB).

In the present embodiment, Multi-Radio Dual Connectivity (MR-DC) in which the eNB 100A constitutes a master node (MN) and the gNB 100B constitutes a secondary node (SN), specifically, E-UTRA-NR Dual Connectivity (EN-DC) may be executed. Alternatively, NR-E-UTRA Dual Connectivity (NE-DC) in which the gNB 100B constitutes an MN and the eNB 100A constitutes an SN may be executed. Alternatively, NR-NR Dual Connectivity (NR-DC) in which the gNB constitutes a MN and an SN may be executed.

Thus, the UE 200 supports dual connectivity that is connected to the eNB 100A and the gNB 100B.

The eNB 100A is included in a master cell group (MCG), and the gNB 100B is included in a secondary cell group (SCG). That is, the gNB 100B is an SN included in the SCG.

The eNB 100A and the gNB 100B may be referred to as a radio base station or a network device.

The radio communication system 10 may also support a conditional addition or a change of a Primary SCell (PSCell) (conditional PSCell addition/change). A PSCell is a type of secondary cell. A PSCell may mean a primary SCell (a secondary cell), and it may be interpreted that any one of several SCells corresponds to a PSCell.

The secondary cell may be read as meaning a secondary node (SN), or a secondary cell group (SCG). The conditional PSCell addition/change makes it possible to realize an addition or a change of the secondary cell efficiently and quickly.

The conditional PSCell addition/change may be interpreted as a procedure for an addition/change of a conditional secondary cell (a secondary node) in which the procedure is simplified. The conditional PSCell addition/change may mean at least one of addition or change of an SCell.

The radio communication system 10 may also support a procedure for a conditional PSCell change between SNs. Specifically, the radio communication system 10 may support MN-initiated conditional PSCell change and/or SN-initiated conditional PSCell change.

### (2) Functional Block Configuration of Radio Communication System

Next, a functional block configuration of the radio communication system 10 will be described. Specifically, the functional block configuration of the eNB 100A, the gNB 100B, and the UE 200 will be described.

### (2.1) eNB 100A and gNB 100B

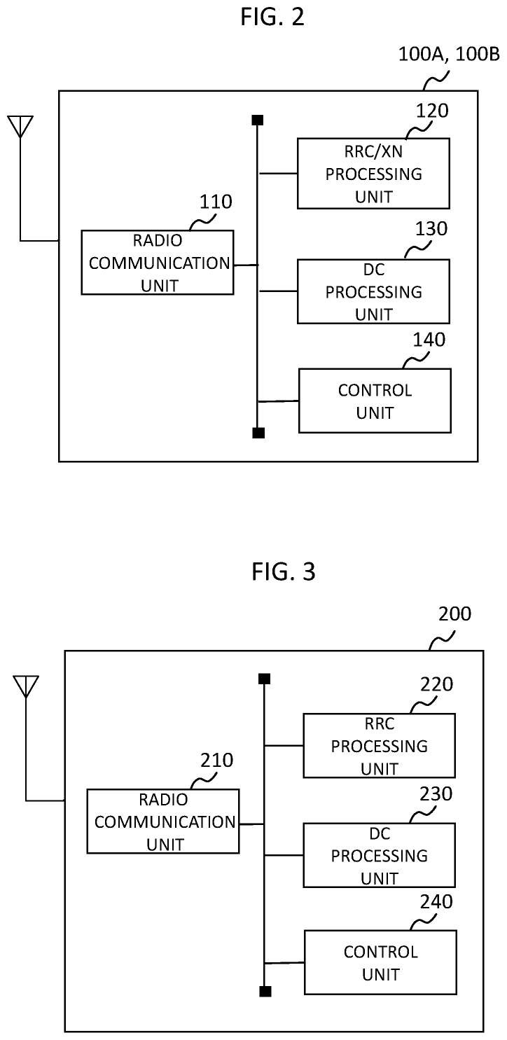

FIG. 2 is a functional block diagram of the eNB 100A and the gNB 100B. As illustrated in FIG. 2, the eNB 100A and the gNB 100B include a radio communication unit 110, an RRC/Xn processing unit 120, a DC processing unit 130, and a control unit 140.

The radio communication unit 110 transmits a downlink signal (DL signal) according to LTE. In addition, the radio communication unit 110 receives an uplink signal (UL signal) according to LTE.

The RRC/Xn processing unit 120 performs various processing relating to a radio resource control layer (RRC) and an Xn interface. Specifically, the RRC/Xn processing unit 120 can transmit an RRC Reconfiguration to the UE 200. In addition, the RRC/Xn processing unit 120 can receive an RRC Reconfiguration Complete, which is a response to the RRC Reconfiguration, from the UE 200.

In the present embodiment, the eNB 100A supports LTE. In this case, the name of an RRC message may be an RRC Connection Reconfiguration, or an RRC Connection Reconfiguration Complete.

In the case where a radio base station supports LTE (Evolved Universal Terrestrial Radio Access Network (E-UTRAN)), an X2 interface may be used instead of an Xn interface. Alternatively, the Xn and X2 interfaces may be used together. The Xn interface will be described below as an example.

The RRC/Xn processing unit 120 can transmit and receive inter-node messages via the Xn interface. For example, when constituting the secondary node (SN), the RRC/Xn processing unit 120 may receive a message (a first message) relating to an SCell (which may include a PSCell; hereinafter, the same shall apply) from another radio base station, specifically, from the master node (MN). In the present embodiment, the RRC/Xn processing unit 120 is a reception unit.

More specifically, the RRC/Xn processing unit 120 may receive from the MN, a message including SN change confirm or Accepted candidate cell info (PSCell ID).

When the RRC/Xn processing unit receives the message (first message), the RRC/Xn processing unit 120 may transmit to the MN (another radio base station), a message (second message) including the update information (execution condition update indication) of an execution condition of a conditional PSCell addition/change. In the present embodiment, the RRC/Xn processing unit 120 is a transmission unit.

More specifically, the RRC/Xn processing unit 120 may transmit SN modification required, or SN change required to the MN. The RRC/Xn processing unit 120 may transmit a newly specified message (a new message) to the MN, instead of SN modification required or SN change required.

The RRC/Xn processing unit 120 may transmit a message (second message) including an information element that distinguishes between an execution condition of the conditional PSCell addition/change and a conditional message of the radio resource control layer, specifically, a conditional RRCReconfig.

Specifically, regarding the signaling of CG-Config included in SN modification required or SN change required, the execution condition may be distinguished from the conditional RRCReconfig. For example, condExecutionConId may be given to the execution condition, condReconfigId may be given to the conditional RRCReconfig, or the execution condition may be associated with the conditional RRCReconfig by a PSCell ID.

The conditional RRCReconfig may be interpreted as an RRC Reconfiguration message that is applied when the condition is met. The condition may be an execution condition of the conditional PSCell addition/change described above.

Meanwhile, when constituting the MN, the RRC/Xn processing unit 120 may receive a message relating to an addition/change of the SCell from another radio base station, specifically, from the SN. The RRC/Xn processing unit 120 may receive a message relating to an addition of the SCell, and a message relating to a change of the SCell.

More specifically, the RRC/Xn processing unit 120 may receive SN change required and/or an SN Addition Request Ack from the SN.

The DC processing unit 130 performs processing relating to dual connectivity, specifically, Multi-RAT Dual Connectivity (MR-DC). In the present embodiment, since the eNB 100A supports LTE and the gNB 100B supports NR, the DC processing unit 130 may perform processing relating to E-UTRA-NR Dual Connectivity (EN-DC). Note that, as described above, the type of DC is not limited, and the DC processing unit 130 may support, for example, NR-E-UTRA Dual Connectivity (NE-DC), or NR-NR Dual Connectivity (NR-DC).

The DC processing unit 130 can transmit and receive messages specified in 3GPP TS37.340 or the like, and perform processing for configuring and releasing DC between the eNB 100A, the gNB 100B, and the UE 200.

The control unit 140 controls each function block constituting the eNB 100A. In particular, in the present embodiment, the control unit 140 performs control relating to an addition or a change of a secondary node.

The control unit 140 controls an execution of a procedure for an addition/change of an SCell, in particular, an execution of the conditional PSCell addition/change. Specifically, the control unit 140 can execute an addition or a change of the SCell based on an execution condition by cooperating with the SN (or the MN).

Further, the control unit 140 may determine whether an execution condition of the conditional PSCell addition/change is updated, based on the respective messages from the SN, specifically, the identification information of the SCell (specifically, PSCell IDs) included in SN change required or SN addition request Ack.

More specifically, the control unit 140 may determine whether the execution condition has been updated based on whether the PSCell IDs included in the respective messages match with each other. If the PSCell IDs match with each other, the control unit 140 may determine that the execution condition has not been updated, and if the PSCell IDs do not match with each other, the execution condition has been updated.

That is, the control unit 140 may determine the content of the conditional message of the radio resource control layer, specifically, the content of the conditional RRCReconfig to be transmitted to the UE 200, based on the matching result between the identification information (PSCell ID) included in the message relating to an addition of the SCell (for example, SN Addition Request Ack) and the identification information (PSCell ID) included in the message relating to a change of the SCell change (for example, SN change required).

For example, an NR Physical Cell ID (PCI), an NR Cell Global Identifier (CGI) may be applied as a PSCell ID.

In the present embodiment, a channel includes a control channel and a data channel. The control channel includes a PDCCH (Physical Downlink Control Channel), a PUCCH (Physical Uplink Control Channel), a PRACH (Physical Random Access Channel), a PBCH (Physical Broadcast Channel), and the like.

The data channel includes a PDSCH (Physical Downlink Shared Channel), a PUSCH (Physical Uplink Shared Channel), and the like.

A reference signal includes a Demodulation Reference Signal (DMRS), a Sounding Reference Signal (SRS), a Phase Tracking Reference (PTRS), Signal a Channel State Information-Reference Signal (CSI-RS), and the like. A signal includes a channel and a reference signal. Further, data may mean data transmitted via a data channel.

### (2.2) UE 200

FIG. 3 is a functional block diagram of the UE 200. As illustrated in FIG. 3, the UE 200 includes a radio communication unit 210, an RRC processing unit 220, a DC processing unit 230, and a control unit 240.

The radio communication unit 210 transmits an uplink signal (UL signal) according to LTE or NR. In addition, the radio communication unit 210 receives a downlink signal (DL signal) according to LTE. In other words, the UE 200 can access the eNB 100A (E-UTRAN 20) and the gNB 100B (NG RAN 30), and can support dual connectivity (specifically, EN-DC).

The RRC processing unit 220 performs various processing in the radio resource control layer (RRC). Specifically, the RRC processing unit 220 can transmit and receive a radio resource control layer message.

The RRC processing unit 220 can receive an RRC Reconfiguration from the network, specifically, from the E-UTRAN 20 (or NG RAN 30). In addition, the RRC processing unit 220 can transmit an RRC Reconfiguration Complete, which is a response to the RRC Reconfiguration, to the network.

The RRC processing unit 220 can also receive a conditional RRCReconfig from the network. The conditional RRCReconfig may be transmitted from the MN, for example.

The DC processing unit 230 performs processing relating to dual connectivity, specifically, MR-DC. As described above, in the present embodiment, the DC processing unit 230 may perform processing relating to EN-DC; however, the DC processing unit 230 may perform processing relating to NE-DC and/or NR-DC.

The DC processing unit 230 can access each of the eNB 100A and the gNB 100B, and perform a configuration in a plurality of layers (a media access control layer (MAC), a radio link control layer (RLC), a packet data convergence protocol layer (PDCP), and the like) including the RRC.

The control unit 240 controls each function block constituting the UE 200. In particular, in the present embodiment, the control unit 240 controls an execution of conditional PSCell addition/change.

Specifically, the control unit 240 may monitor an execution condition of the conditional PSCell addition/change, and determine whether a target PSCell exists that meets the execution condition. When a target PSCell exists that meets the execution condition, the control unit 240 may return the RRC Reconfiguration Complete to the MN in order to request the MN to perform an RRC reconfiguration of the target PSCell.

### (3) Operation of Radio Communication System

Next, an operation of the radio communication system 10 will be described. Specifically, the operation of the radio communication system 10 regarding a procedure for an addition/change of a conditional secondary cell (secondary node) (conditional PSCell addition/change) will be described.

### (3.1) Assumption and Problem

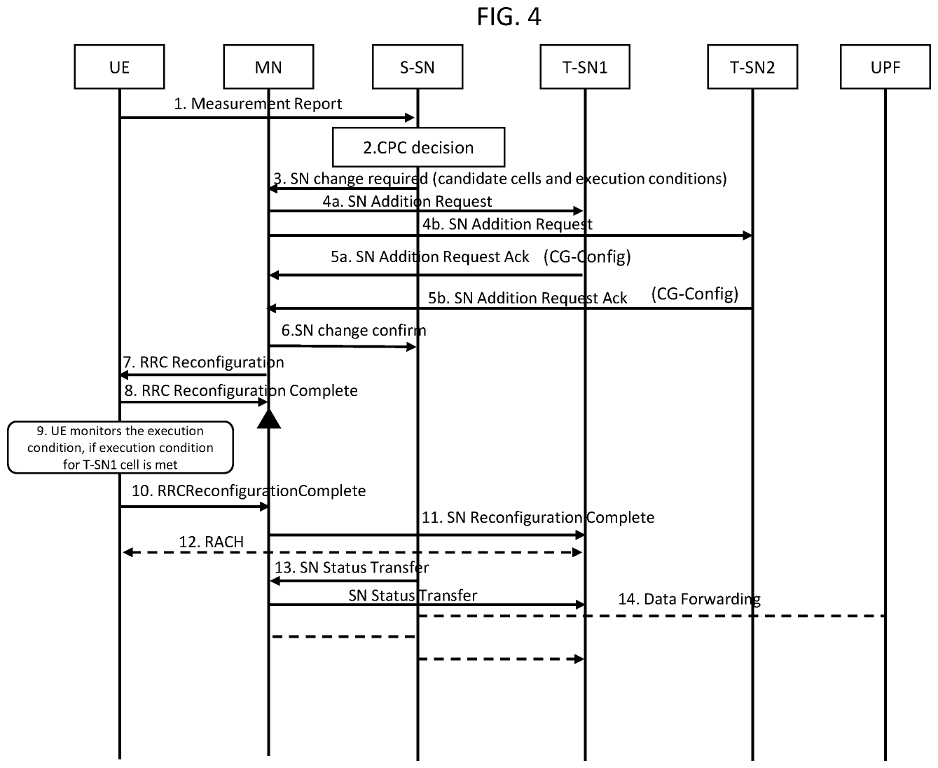

FIG. 4 illustrates a sequence example (part 1) of SN-initiated conditional PSCell change assumed in 3GPP Release 17. As illustrated in FIG. 4, the source secondary node (S-SN) (for example, gNB 100B) determines the conditional PSCell change (CPC) (step 2), and transmits SN change required to the MN (step 3). “SN change required” may include a candidate cell and an execution condition.

The MN transmits an SN Addition Request to the target secondary node (T-SN) (steps 4a and 4b), and the T-SN returns an SN Addition Request Ack (steps 5a and 5b) to the MN. The SN Addition Request Ack may include cell group configuration information (CG-Config).

If the MN is an eNB and the SN is a gNB, the UE 200 monitors an execution condition, and if a target PSCell exists that meets the execution condition, the UE 200 returns the RRC Reconfiguration Complete to the MN in order to request the MN to perform an RRC reconfiguration of the target PSCell (steps 7 and 8).

If the SN uses FR2 (24.25 GHz to 52. 6 GHz) (please see a triangle mark in the figure), an FR2 measurement gap can be configured in cell measurement (In EN-DC, only the SN can configure an FR2 measurement gap); however, if a candidate cell in which the FR2 measurement gap is configured is not accepted by the T-SN, the measGapConfig is no longer necessary and needs to be deleted. If the measGapConfig is not deleted, the UE 200 cannot transmit and receive data during the FR2 measurement gap period, which may lead to a reduction in throughput.

This causes a problem about how to update the execution condition (such as deletion of measGapConfig that is no longer necessary).

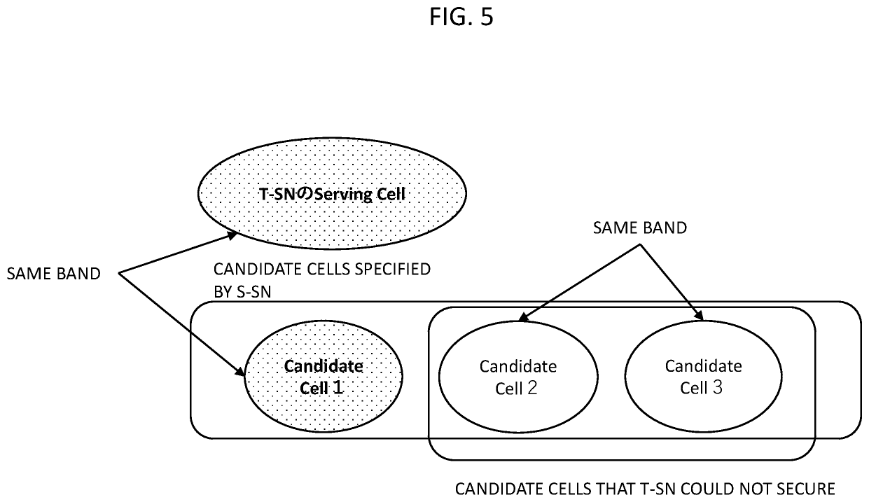

FIG. 5 illustrates an example of the relationship between a serving cell of the T-SN and candidate cells specified by the S-SN. In the example illustrated in FIG. 5, the serving cell of the T-SN, and the candidate cell 1 (candidate cell) specified by the S-SN use the same band, and the candidate cell 2 and the candidate cell 3 specified by the S-SN use the same band (which may be different from the serving cell of the T-SN).

In such a case, there is a possibility that the T-SN can secure only the candidate cell 1 specified by the S-SN, and cannot secure the candidate cell 2 and the candidate cell 3 specified by the S-SN, and thus the S-SN determines to change the execution condition.

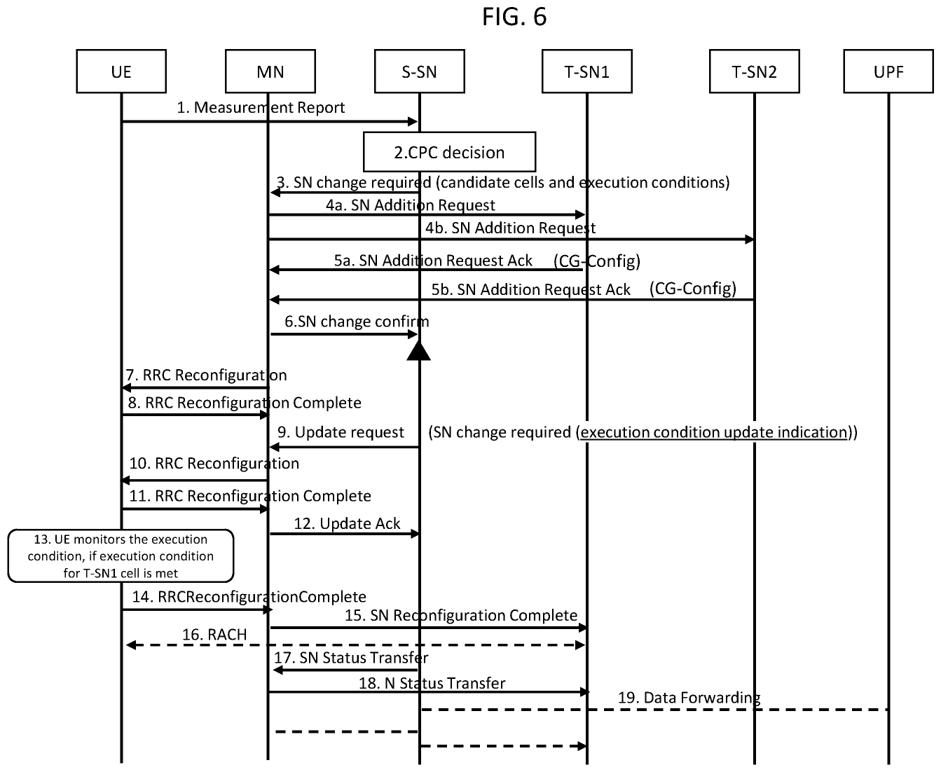

FIG. 6 illustrates a sequence example (part 2) of SN-initiated conditional PSCell change assumed in 3GPP Release 17. The sequence illustrated in FIG. 6 is intended to solve the problem of the sequence illustrated in FIG. 4.

As illustrated in FIG. 6, the S-SN can determine the necessity of updating the RRC Reconfiguration (execution condition) (see a triangle mark in the figure), and request the MN to update the RRC Reconfiguration (steps 9 and 12).

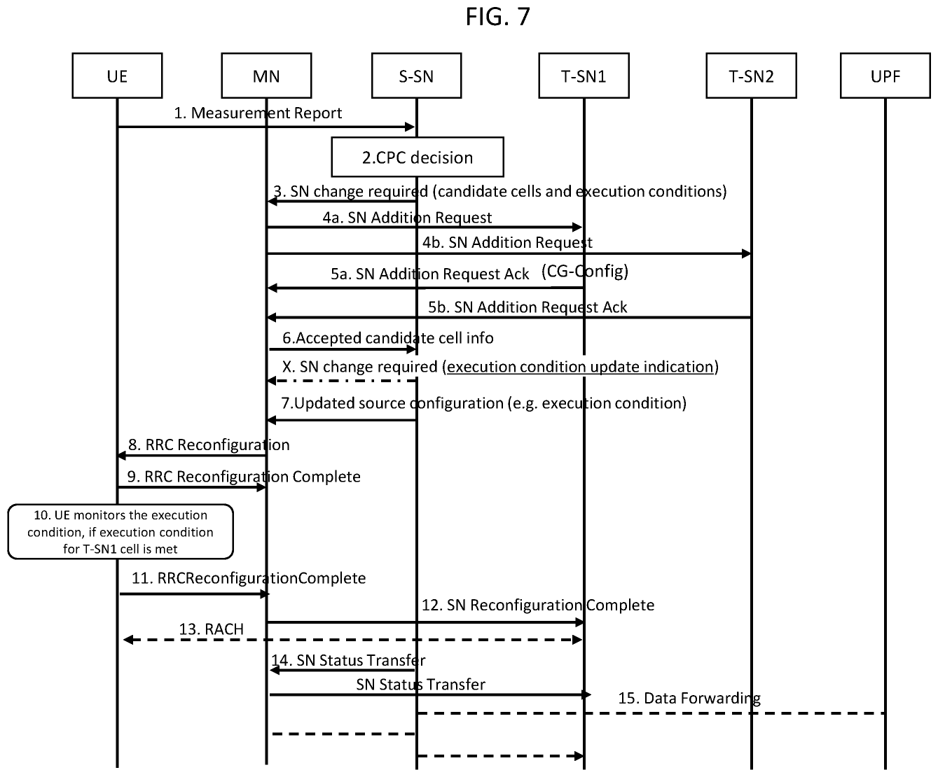

FIG. 7 illustrates a sequence example (part 3) of SN-initiated conditional PSCell change assumed in 3GPP Release 17. The sequence illustrated in FIG. 7 is also intended to solve the problem of the sequence illustrated in FIG. 4.

As illustrated in FIG. 7, the MN may transmit Accepted candidate cell info to the S-SN. Thereafter, the S-SN may respond to the Accepted candidate cell info and return Updated source configuration to the MN (steps 6 and 7). The Updated source configuration may include an updated execution condition.

However, the sequences shown in FIGS. 6 and 7 still have the following problems.
(Problem 1): When applying an update request as illustrated in FIG. 6, it is unclear what kind of message (inter-node message) is specifically used. It is also unclear how an execution condition is actually updated.
(Problem 2): In the case where the messages (Accepted candidate cell info and Updated source configuration) as illustrated in FIG. 7 are used, if the candidate cell specified by the S-SN due to SN change required matches the candidate cell accepted by the T-SN due to the SN Addition Request Ack, the Updated source configuration is unnecessary; however, according to the sequence of FIG. 7, the MN has to wait for the receipt of the Updated source configuration, which causes a delay.

Meanwhile, if the candidate cells do not match with each other, it is not necessary for the S-SN to update the execution condition, and the MN may update the execution condition. That is, there is room for further improvement in the sequence.

A description will be given regarding an operation example with which it is possible to solve the above problems 1 and 2.

### (3.2) Operation Example

### (3.2.1) Operation Example 1

A description will be given regarding the present operation example with which it is possible to solve the problem 1. Specifically, in SN-initiated conditional PSCell change, when the S-SN receives an SN change confirm from the MN, in the case where the candidate PSCell accepted by the T-SN is different from the PSCell notified from the S-SN to the MN due to SN change required, it is necessary to change the execution condition configured by the S-SN.

For example, as described above, if the SN uses a band of FR2, an FR2 measurement gap can be configured in the cell measurement; however, if a candidate cell that has configured a measGap is not accepted by the T-SN, the measGapConfig is no longer necessary, and if the measGapConfig is not deleted, which may lead to a reduction in throughput of the UE 200.

In the present operation example, the message used for the change, and the change method are specified. Specifically, after receiving a message including an SN change confirm or accepted candidate cell info (PSCell ID), the S-SN may include an execution condition update indication in SN change required (or in SN modification required), or in a new message.

For example, as illustrated in FIG. 6, SN change required may be used as an update request (step 9), and an execution condition update indication may be included in the SN change required. Alternatively, as illustrated in FIG. 7, after receiving the accepted candidate cell info, the S-SN may transmit SN change required including an execution condition update indication (step X).

Further, regarding the signaling of CG-Config included in SN change required (or SN modification required), an execution condition and conditional RRCReconfig may be separated. In addition, condExecutionConId and condReconfigId may be assigned to each of an execution condition and conditional RRCReconfig. Furthermore, an execution condition and conditional RRCReconfig may be associated with each other by a PSCell ID.

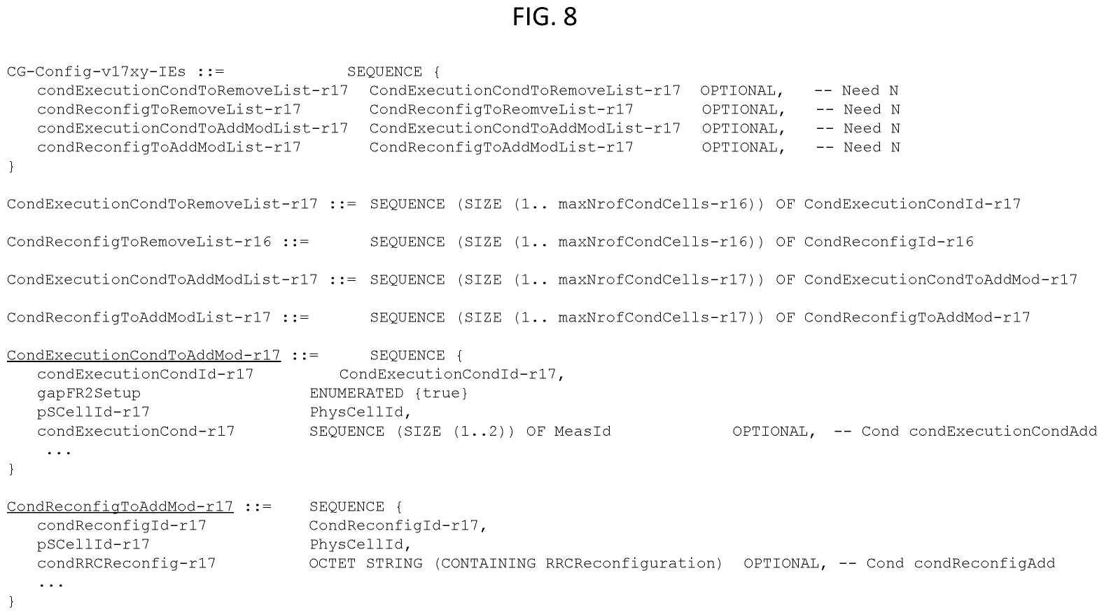

FIG. 8 illustrates a configuration example (ASN.1 format) of CG-Config according to operation example 1. As illustrated in FIG. 8, in the CG-Config included in SN change required/SN modification required/SN Addition Request Ack, the information element of execution condition and the information element of conditional RRCReconfig (which may be read as meaning a field) may be described separately (see underlined parts). In addition, the CG-Config may be applied to the operation example 2 described later.

The S-SN may determine a PSCell ID that is not accepted, based on the PSCell ID information of the accepted candidate cell included in SN change confirm and the candidate cell information (PSCell ID) included in SN change required, and extract an unnecessary execution condition ID that is associated with the determined PSCell ID. Alternatively, if an unnecessary measGap (for example, gapFR2) is configured, and the measConfig may be updated by deleting the measGap.

The S-SN may transmit SN modification required or SN change required including condExecutionCondToRemoveList to the MN. The MN may remove an unnecessary execution condition (measId) and transmit an updated conditional RRCReconfig to UE 200, based on the received condExecutionCondToRemoveList. Alternatively, the SN may transmit an updated execution condition list (in which the unnecessary execution condition is deleted) or an updated measConfig (in which the unnecessary measGap is deleted, for example), to the MN.

In the procedure (sequence) for conditional PSCell addition/change (CPAC), the present operation example makes it possible to clarify the message to be used when the execution condition needs to be updated and the method for changing the execution condition, thereby updating the execution condition in the CPAC more reliably.

### (3.2.2) Operation Example 2

A description will be given regarding the present operation example with which it is possible to solve the problem 2. Specifically, the steps 6 and 7 illustrated in FIG. 7 (Accepted candidate cell info, Updated source configuration) are required in order to match a candidate cell specified by the S-SN with a resource secured by the T-SN. However, if a resource of the specified cell is secured, the MN does not need to wait for the Updated source configuration.

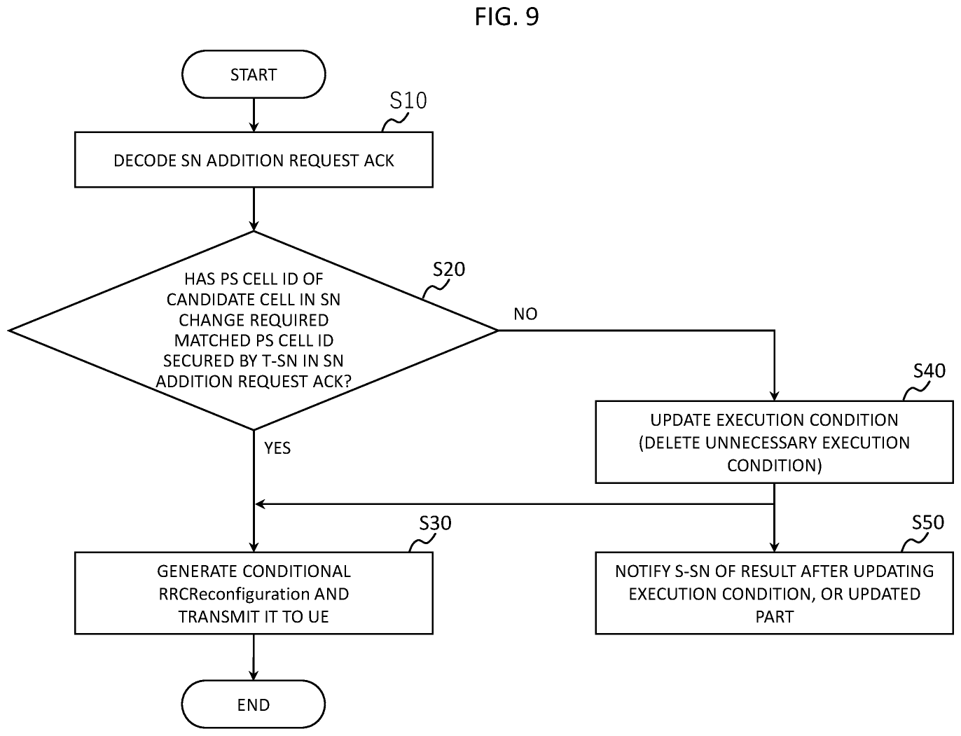

FIG. 9 illustrates an example of an operation flow of the MN according to operation example 2. As illustrated in FIG. 9, the MN decodes an SN Addition Request Ack transmitted from the T-SN (S10).

The MN checks whether the cell information (PSCell ID) and an execution condition included in SN change required, and a conditional RRCReconfig (CondReconfigToAddModList) included in SN Addition Request Ack match a PSCell ID acquired by decoding an SN Addition Request Ack, and determines whether the execution condition is updated (S20). That is, the MN determines whether a PSCell ID of the candidate cell (which may be a plurality of cells) in SN change required matches a PSCell ID secured by the T-SN in SN Addition Request Ack.

Here, if the PSCell IDs match with each other, the MN does not need to wait for Updated source configuration (execution update) from the SN, and may combine an RRC Reconfiguration with an execution condition to generate a conditional RRCReconfig, and may transmit the generated conditional RRCReconfig to the UE 200 (S30).

Meanwhile, if the PSCell IDs does not match with each other, that is, the matching result indicates a mismatch, the MN may wait for Updated source configuration (execution update) from the SN, update an execution condition or measConfig to generate a conditional RRCReconfig using the updated execution condition or measConfig, and may transmit the generated conditional RRCReconfig to the UE 200 (S40).

Alternatively, the MN may determine a candidate cell that the T-SN did not accept, from a PSCell ID included in SN Addition Request Ack, and find an execution condition ID from CondExecutionCondToAddMod associated with the PSCell ID (see FIG. 8), and the MN may delete the execution condition, combine the updated execution condition with the RRC Reconfiguration of the candidate cell that the T-SN has accepted, then generate a conditional RRCReconfig, and transmit the generated conditional RRCReconfig to the UE 200.If gapFR2Setup is configured to be “true” in CondExecutionCondToAddMod (see FIG. 8), the MN may wait for Updated source configuration (execution condition and measConfig update) from the SN.

Thereafter, the MN may delete the execution condition ID and notify the SN (S-SN) that the execution condition has been updated (S50).

According to the present operation example, in the procedure (sequence) for conditional PSCell addition/change (CPAC), the conditional RRCReconfig can be transmitted to the UE 200 more quickly when the execution condition needs to be updated, thereby reducing the delay in configuring the CPAC and the number of signals, and achieving the CPAC more efficiently.

### (4) Operation and Effect

According to the above-described embodiment, when the radio base station constituting the SN receives a specific message (SN change confirm or Accepted candidate cell info), the radio base station can transmit a message (SN modification required or SN change required) including an execution condition update indication to the MN.

Further, the radio base station constituting the MN can determine whether an execution condition of conditional PSCell addition/change is updated, based on a PSCell ID included in the specific message (SN change required or SN Addition Request Ack). For this reason, an execution condition of the conditional PSCell addition/change can be appropriately updated.

Accordingly, even in situations where the conditional PSCell addition/change is likely to fail, such as FR2, an execution condition can be more reliably updated, thereby making it possible to further improve the reliability of the conditional PSCell addition/change.

### (5) Other Embodiments

Although the embodiment has been described as above, the present disclosure is not limited to the description of the embodiment, and it is obvious to those skilled in the art that various modifications and improvements are possible.

For example, in the embodiment described above, a description has been given regarding EN-DC in which an MN is an eNB and an SN is a gNB as an example; however, as described above, other DCs may be used. Specifically, NR-DC in which an MN is a gNB and an SN is a gNB, or NE-DC in which an MN is a gNB and an SN is an eNB may be used.

In the above-described embodiment, the conditional PSCell addition/change has been mainly described as an example; however, the above-described operation example may be applied to a CHO (Conditional Handover), or Conditional SCG change.

In the above description, configure, activate, update, indicate, enable, specify, and select may be interchangeably interpreted. Similarly, link, associate, correspond, and map may be interchangeably interpreted, and allocate, assign, monitor, and map may also be interchangeably interpreted.

In addition, specific, dedicated, UE-specific, and UE-dedicated may be interchangeably interpreted. Similarly, common, shared, group-common, UE-common, and UE-shared may be interchangeably interpreted.

The block diagram (FIGS. 2 and 3) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

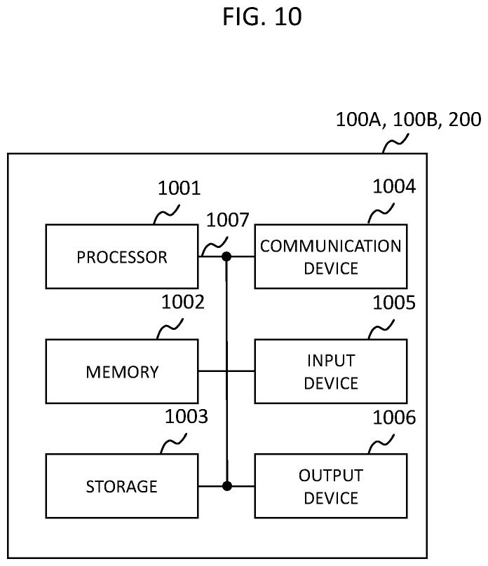

Further, the above-described eNB 100A, gNB 100B, and UE 200 (the device) may function as a computer that performs processing of a radio communication method of the present disclosure. FIG. 10 is a diagram illustrating an example of a hardware configuration of the device. As illustrated in FIG. 10, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIGS. 2 and 3) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and performs various processes according to these. As the program, a program causing the computer to perform at least part of the operation described in the above embodiment is used. Alternatively, various processes described above may be performed by one processor 1001 or may be performed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can perform the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel.

Similarly, the mobile station in the present disclosure may be read as meaning a base station. In this case, the base station may have the function of the mobile station. A radio frame may be composed of one or more frames in the time domain. Each of the one or more frames in the time domain may be referred to as a subframe. A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a physical resource block (PRB), a subcarrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10: radio communication system
20: E-UTRAN
30: NG RAN
40: UPF
100A: eNB
100B: gNB
110: radio communication unit
120: RRC/Xn processing unit
130: DC processing unit
140: control unit
200: UE
210: radio communication unit
220: RRC processing unit
230: DC processing unit
240: control unit
1001: processor
1002: memory
1003: storage
1004: communication device
1005: input device
1006: output device
1007: bus

1. A radio base station comprising:
a control unit that controls an execution of procedure for an addition/change of a secondary cell;
a reception unit that receives first message relating to the secondary cell from another base station; and
a transmission unit that transmits a second message including update information of an execution condition of the procedure for the addition/change to another base station when receiving the first message.

2. The radio base station according to claim 1, wherein
the transmission unit transmits the second message including an information element that distinguishes between the execution condition and a conditional message of a radio resource control layer.

3. A radio communication method comprising:
a step of controlling an execution of a procedure for an addition/change of a secondary cell;
a step of receiving a first message relating to the secondary cell from another base station; and
a step of transmitting a second message including update information of an execution condition of the procedure for the addition/change to another base station when receiving the first message.

4. A radio base station comprising:
a control unit that controls an execution of a procedure for an addition/change of a secondary cell; and
a reception unit that receives a message relating to the addition/change of the secondary cell from another base station, wherein
the control unit determines an execution condition of the procedure for the addition/change is updated, based on identification information of the secondary cell included in the message.

5. The radio base station according to claim 4, wherein
the reception unit receives a message relating to an addition of the secondary cell, and a message relating to a change of the secondary cell, and
the control unit determines a content of a conditional message of a radio resource control layer, based on a matching result between the identification information included in the message relating to the addition of the secondary cell and the identification information included in the message relating to the change of the secondary cell.

6. A radio communication method comprising:
a step of controlling an execution of a procedure for an addition/change of a secondary cell;
a step of receiving a message relating to the addition/change of the secondary cell from another base station; and
a step of determining whether an execution condition of the procedure for the addition/change is updated, based on identification information of the secondary cell included in the message.
